(19) United States
(12) Patent Application Publication
(10) Pub. No.: US 2021/0224735 A1
(43) Pub. Date: Jul. 22, 2021

(54) SYSTEMS AND METHODS FOR ELECTRONIC MANAGEMENT OF TRACKABLE AND REUSABLE SHIPPING CONTAINERS

(71) Applicant: COUPANG CORP., Seoul (KR)

(72) Inventors: Erik REHN, Seoul (KR); Akshaya GOWRISHANKER, Seoul (KR); Peijun XIE, Shanghai (CN); Yoo Suk KIM, Seoul (KR); Yoon Hyung LEE, Gyeonggi-do (KR)

(21) Appl. No.: 16/745,328

(22) Filed: Jan. 16, 2020

(51) Int. Cl. G06Q 10/08

(52) U.S. Cl. CPC G06Q 10/0833

(57) ABSTRACT

A computerized system for reusable storage tracking and distribution, comprising: at least one processor to perform steps comprising: receiving an order associated with a customer and comprising at least one item; searching at least one data store to determine tags and properties associated with each item; determining that the customer is assigned to one or more reusable packages for delivery of the; sorting the items into at least one group; determining a count of reusable packages; generate an indication of an identifier for each item in the group and an associated reusable package; sending the generated instructions to a first mobile device; sending a communication to a second mobile device associated with a delivery worker, comprising: a reusable package identifier; a delivery location; and a number of reusable packages for pickup; receiving a scan event from the second mobile device, comprising an identifier of a second reusable package.

### TECHNICAL FIELD

The present disclosure generally relates to computerized systems and methods for managing thermally insulated reusable packaging. In particular, embodiments of the present disclosure relate to inventive and unconventional systems and methods utilized for packaging items for delivery in reusable cooler bags, and tracking the reusable cooler bags through the delivery cycle.

### BACKGROUND

Product delivery business traditionally relies on conventional packaging, such as cardboard boxes or plastic wrapping, to package products for delivery. Conventional packaging is typically single use, and thus creates wastes when customer discard the packaging once the product has been delivered. Moreover, conventional packaging lacks sufficient temperature insulation, thus is not suitable for packaging fresh produce or frozen items.

Temperature insulated packaging, or “cooler bag,” may be employed to contain fresh produce or frozen items for delivery. Moreover, such cooler bags may be reused for many subsequent deliveries, and thus eliminate unnecessary wastes and lessen environmental impact. Unlike conventional packaging, reusable cooler bags are expensive to produce. As a consequence, total amount of reusable cooler bags that are currently in use are limited due to cost, and the cost to replace lost or damaged reusable cooler bags may be prohibitive. Therefore, efficient use and tracking of the reusable cooler bags are critical.

Prior systems and methods for deploying the reusable cooler bags are inefficient, leading too many reusable cooler bags sitting idle and not being used. Moreover, prior systems and methods are inadequate in tracking the locations of the reusable cooler bags, leading to an excessive number of reusable cooler bags being lost or stolen.

Therefore, there is a need for improved methods and systems for efficient deployment and tracking of the reusable cooler bags, such that their limited numbers can be utilized to the maximum effect, and the replacement rate due to losses are kept at minimum.

### SUMMARY

One aspect of the present disclosure is directed to a computerized system for reusable storage tracking and distribution, comprising: at least one processor; and at least one non transitory storage medium comprising instructions that, when executed by the at least one processor, cause the at least one processor to perform steps comprising: receiving, from a remote system, an order associated with a customer and comprising at least one item; searching at least one data store to determine one or more tags and one or more properties associated with each item; determining that the customer is assigned to one or more reusable packages for delivery of the items in the order; based on the determined tags and the number of items in the order, sorting the items into at least one group; for at least one group: determining, based on the number of items in the group and the dimensions of the items in the group, a count of reusable packages; generate instructions comprising: an indication of an identifier for each item in the group and an associated reusable package for packaging the respective item; sending the generated instructions to a first mobile device for display; sending a communication to a second mobile device associated with a delivery worker, comprising: a reusable package identifier; a delivery location; and a number of reusable packages for pickup; receiving a scan event from the second mobile device, comprising an identifier of a second reusable package.

Another aspect of the present disclosure is directed to a method for reusable storage tracking and distribution, comprising: receiving, from a remote system, an order associated with a customer and comprising at least one item; searching at least one data store to determine one or more tags and one or more properties associated with each item; determining that the customer is assigned to one or more reusable packages for delivery of the items in the order; based on the determined tags and the number of items in the order, sorting the items into at least one group; for at least one group: determining, based on the number of items in the group and the dimensions of the items in the group, a count of reusable packages; generate instructions comprising: an indication of an identifier for each item in the group and an associated reusable package for packaging the respective item; sending the generated instructions to a first mobile device for display; sending a communication to a second mobile device associated with a delivery worker, comprising: a reusable package identifier; a delivery location; and a number of reusable packages for pickup; receiving a scan event from the second mobile device, comprising an identifier of a second reusable package.

Yet another aspect of the present disclosure is directed to a computerized system for reusable storage tracking and distribution, comprising: at least one processor; and at least one non transitory storage medium comprising instructions that, when executed by the at least one processor, cause the at least one processor to perform steps comprising: receiving, from a remote system, an order associated with a customer and comprising at least one item; searching at least one data store to determine one or more tags and one or more properties associated with each item; determining that the customer is assigned to one or more reusable packages for delivery of the items in the order, wherein a number of reusable packages assigned to the customer is less than a reusable package limit; based on the determined tags and the number of items in the order, sorting the items into at least one group; for at least one group: determining, based on the number of items in the group and the dimensions of the items in the group, a count of reusable packages, wherein the count of reusable packages is less than or equal to the number of reusable packages assigned to the customer; generate instructions comprising: an indication of an identifier for each item in the group and an associated reusable package for packaging the respective item; sending the generated instructions to a first mobile device for display; sending a communication to a second mobile device associated with a delivery worker, comprising: a reusable package identifier; a delivery location; and a number of reusable packages for pickup; receiving a scan event from the second mobile device, comprising an identifier of a second reusable package.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 1F is a schematic block diagram illustrating an exemplary embodiment of a Bag Management System.

FIG. 2 is a diagrammatic illustration of an exemplary fulfillment center configured to utilize disclosed computerized systems, consistent with the disclosed embodiments.

FIG. 3 depicts an exemplary embodiment of a reusable cooler bag, consistent with the disclosed embodiments.

FIG. 4 is a flow chart illustrating an exemplary embodiment of a method for deploying the reusable cooler bag, consistent with the disclosed embodiments.

FIG. 5 is a flow chart illustrating an exemplary embodiment of a method for efficient packaging of ordered items in the reusable cooler bag, consistent with the disclosed embodiments.

FIG. 6 is a schematic diagram illustrating an exemplary embodiment of a method for deploying and tracking the reusable cooler bags, consistent with the disclosed embodiments.

FIG. 7 is a flow chart illustrating an exemplary embodiment of a method for deploying and tracking the reusable cooler bags, consistent with the disclosed embodiments.

FIG. 8 depicts an embodiment of packing a reusable cooler bag containing multiple types of items, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to computer-implemented systems and methods for managing reusable cooler bags. The disclosed embodiments provide innovative technical features that allow for efficient allocation of a limited stock of reusable bags, by leveraging SKU based inventory management technology, mobile network infrastructure and existing transportation infrastructure to ensure that the maximum number of reusable bags are in circulation for use. For example, the disclosed embodiments enable efficient packaging of only eligible items that are appropriate for reusable cooler bags, timely pick-up of unused reusable cooler bags that may be idling with the customer, and efficient returning of these bags without requiring excessive trips by the delivery person. At the same time, the innovative uses of mobile network infrastructure and mobile devices provide accurate accounting of all reusable cooler bags at different points of a delivery cycle, reducing misplacement and theft.

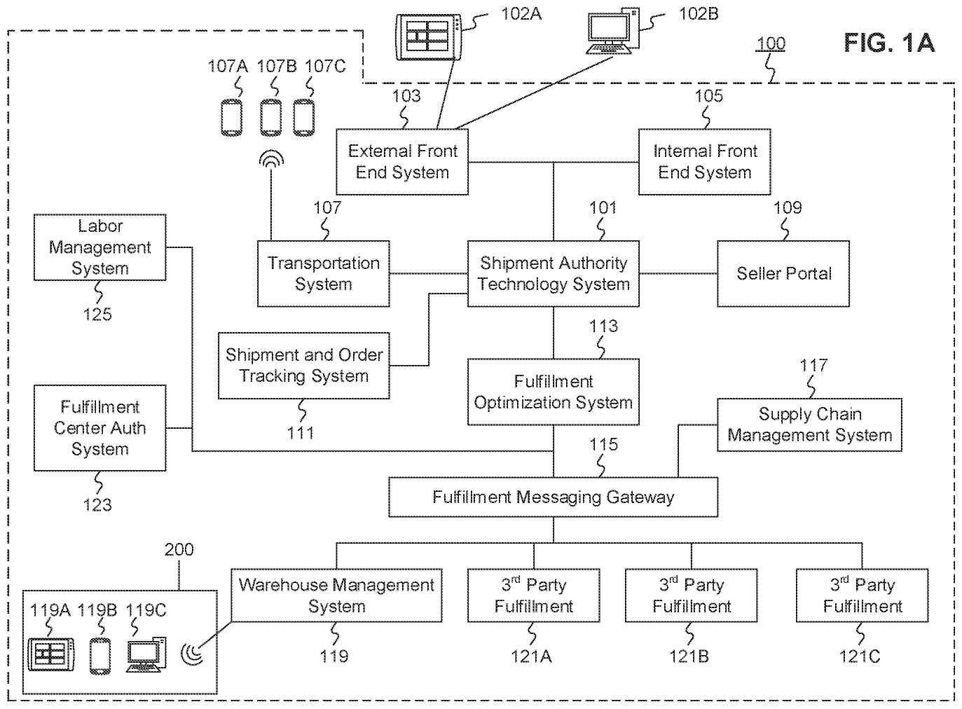

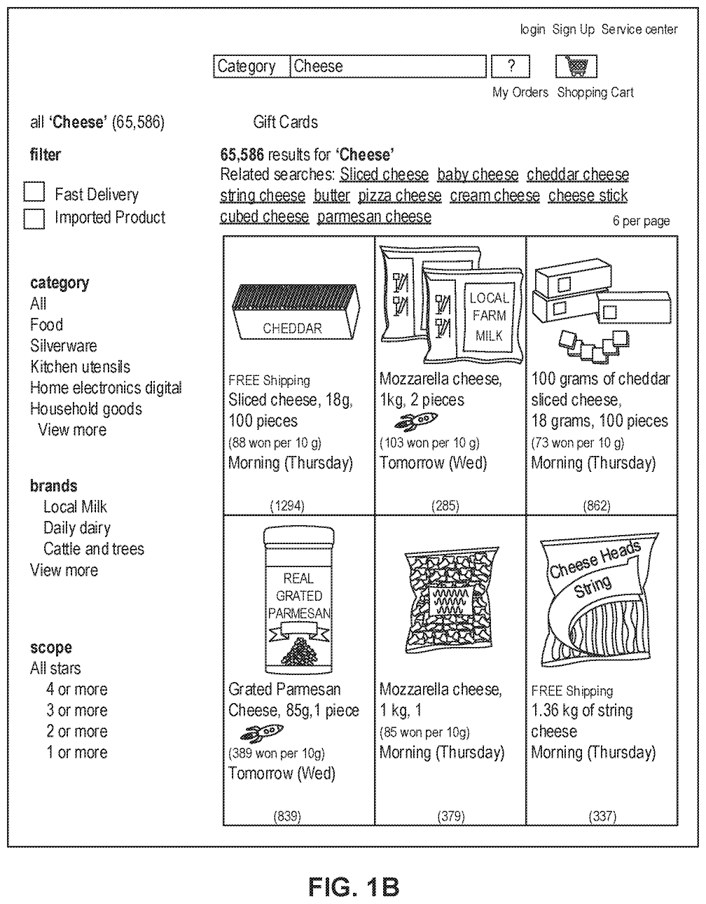

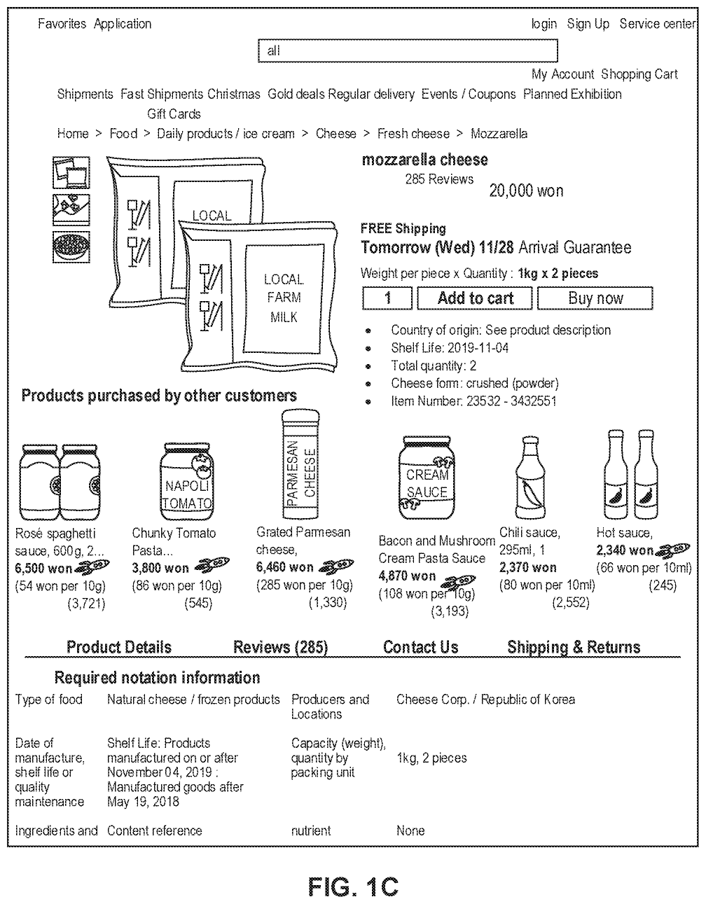

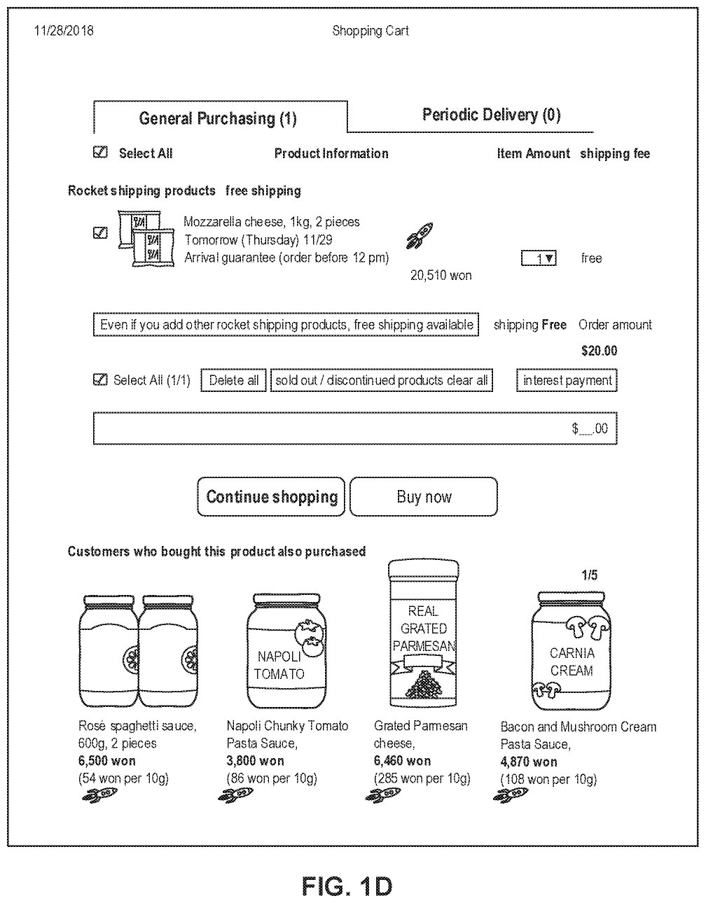

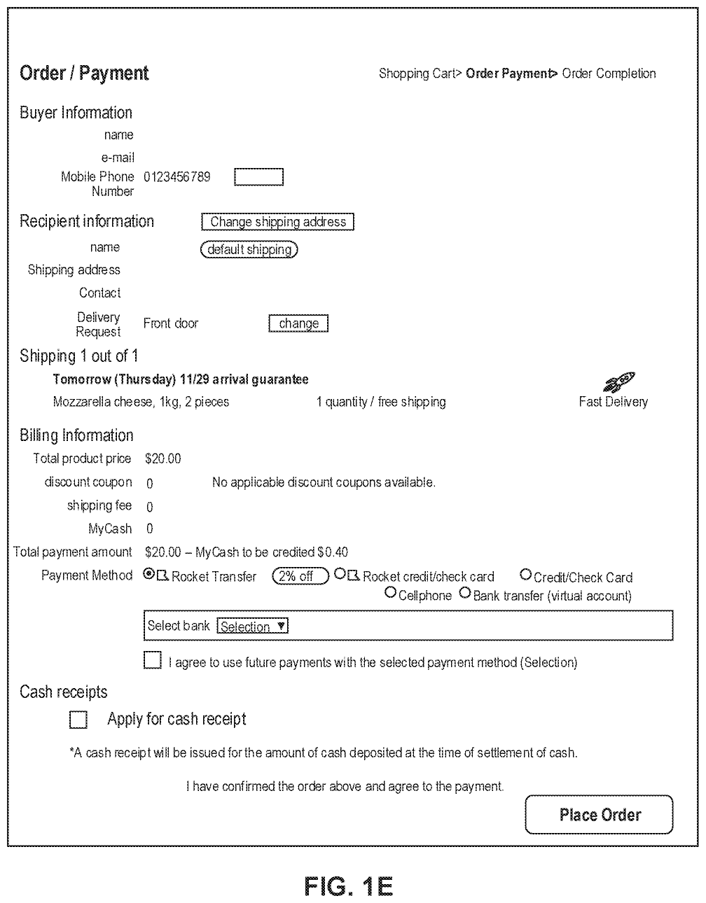

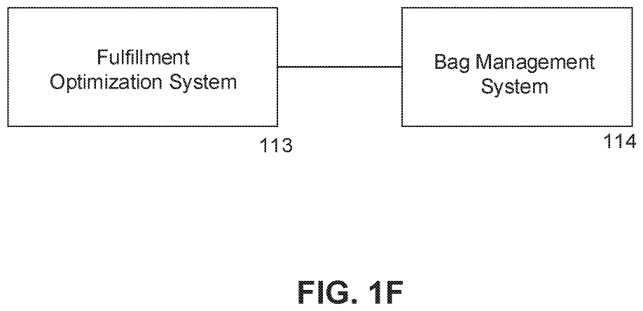

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 1078, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

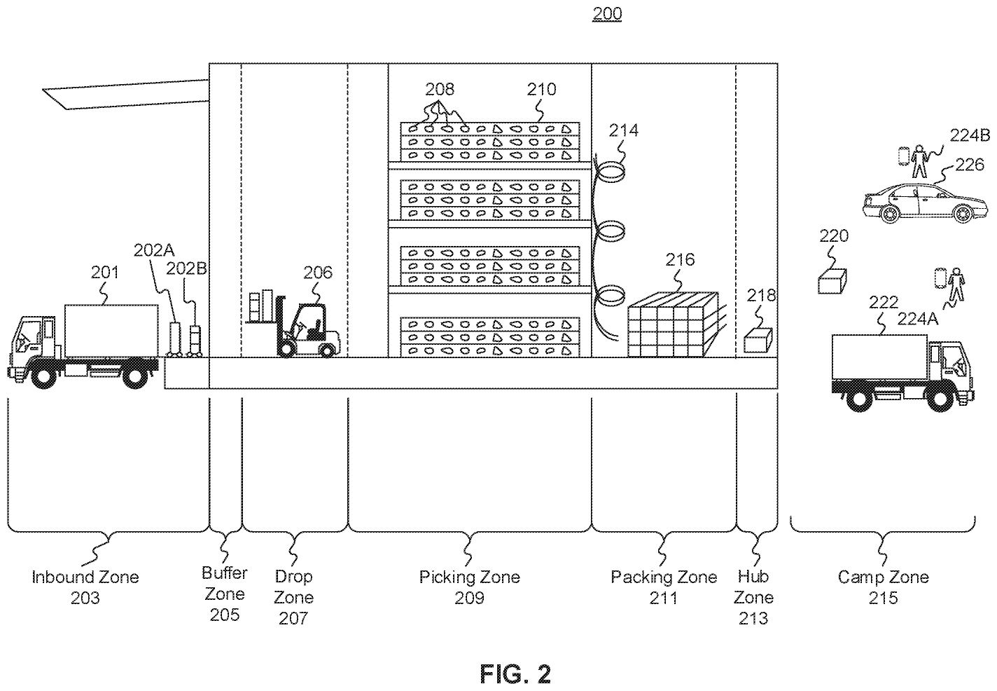

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

In some embodiment, FO system 113 may be further connected to Bag Management System (BMS) 114, as illustrated in FIG. 1F. In some embodiment, BMS 114 may be a subsystem of FO system 113, alternatively, BMS 114 may be an independent system in communication with FO system 113 and rest of system 100.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

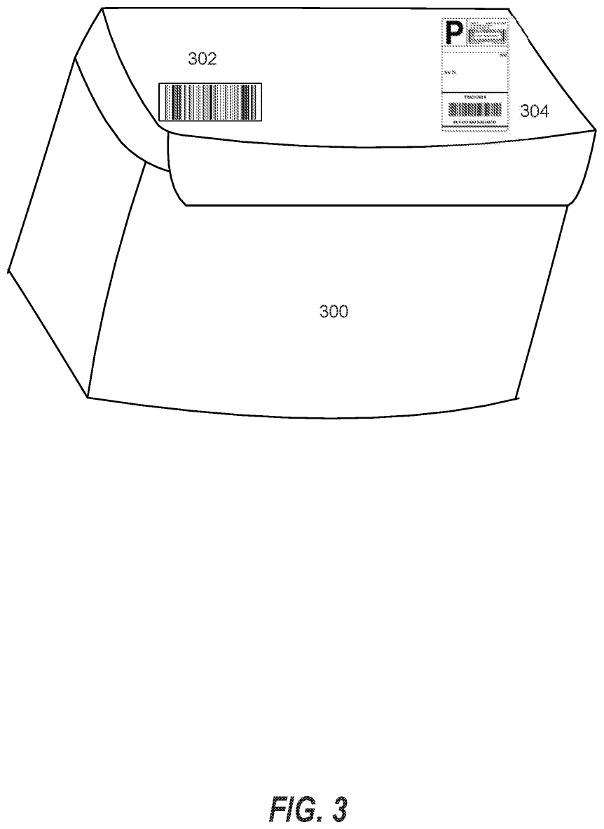

FIG. 3 depicts an exemplary embodiment of a reusable cooler bag 300. In some embodiments, walls of reusable cooler bag 300 may be constructed from appropriate materials to provide thermal insulation for items placed inside. For example, the walls of reusable cooler bag 300 may be multi-layered, having an exterior layer to protect against wear and tear, a middle layer to provide insulation, and an interior that is water resistant. An ordinary skilled person will appreciate that reusable cooler bag 300 is not limited to particular shapes, designs and materials, and that other examples of thermally insulating packaging may be used in alternative embodiments of reusable cooler bag 300.

In some embodiments, reusable cooler bag 300 may contain an identifier and/or a shipping label. Identifier may be an automatic identification and data capture (AIDC) system, such as a barcode 302, QR code, RFID or similar systems. In some embodiments, identifier may be uniquely assigned to specific reusable cooler bag 300. Identifier, such as barcode 302, allows mobile devices 107A-107C to access information relating to reusable cooler bag 300 through in an interaction, such as scanning a barcode. In some embodiments, this interaction also enables various systems, such as Transportation System 107, to keep track of reusable cooler bag 300. Tracking of reusable cooler bag 300 is described further below.

In some embodiments, shipping label 304 may be included on reusable cooler bag 300. Shipping label 304 may contain information related to delivery order such as recipient, destination address, and/or order number. These information enable delivery persons and customers to identify reusable cooler bag 300 based on visual inspection. In some embodiments, shipping label 304 may also comprise AIDC such as a barcode or QR code. Shipping label 304 may, in some embodiments, comprise a shipping label for a mail service (e.g., a postal service operated by or with the authority of a national government), a shipping company (e.g., a company in the business of shipping goods), a company that owns the cooler bag 300, or the like.

In some alternative embodiments, reusable cooler bag 300 may omit shipping label 304. For example, information related to delivery order, such as recipient, destination address, and/or order number may be accessed by delivery persons through barcode 302, without shipping label 304. By omitting shipping label 304, personal information belonging to a customer will not be visually available on reusable cooler bag 300, thus an individual nearby reusable cooler bag 300 will not gain information such as name or address by looking at reusable cooler bag 300.

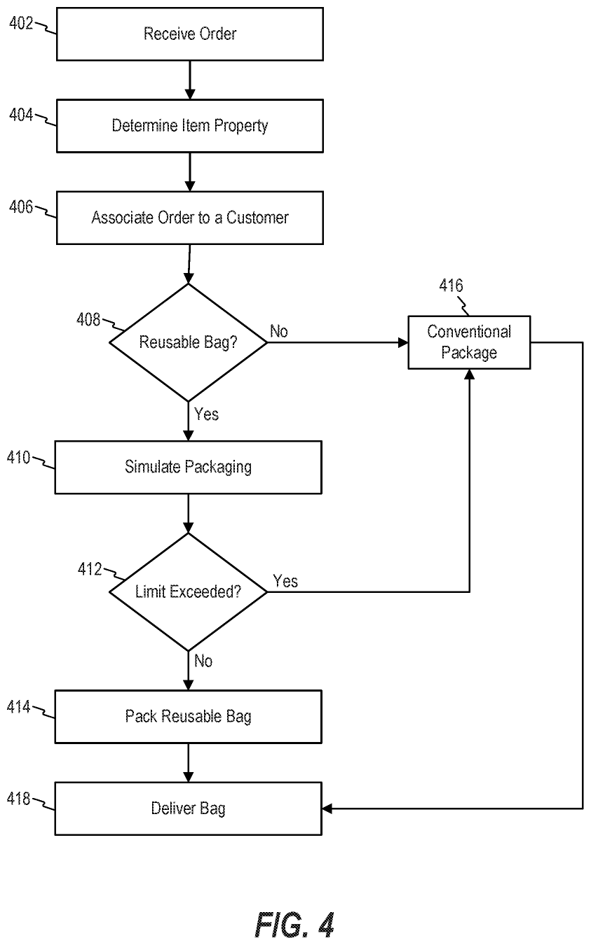

FIG. 4 illustrates a flow chart illustrating an exemplary embodiment of a method for deploying the reusable cooler bag. In step 402, FO system 113 receives an order for items. In some embodiments, a customer may place the order through interaction with one or more systems in system 100 depicted in FIG. 1A. For example, external front end system 103 allows the customer to interact with system 100 through external devices (e.g., mobile device 102A or computer 102B). The order contains data, i.e. information, about the order itself, such items contained in the order, quantity of each items in the order, total cost of the ordered items, etc.

In step 404, FO system 113 collects information about the items contained in the order. As previously described with reference to FIG. 1A, one or more databases connected to system 100 stores information regarding items available for purchase and processing. In some embodiments, information regarding the item may be stored in form of a data structure containing a plurality of fields corresponding to various properties associated with the item. For example, a property in a data structure associated with a particular item may indicate whether this item requires thermally insulated packaging. In alternative examples, one or more properties in the data structure associated with the particular item may indicate that the item is fresh, frozen, perishable or non-perishable, or combination thereof. In some embodiments, FO system 113 accesses information regarding the items in the order from the one or more databases, wherein the information include the various properties of the item. Based on the various properties of the item, FO system 113 determines whether the individual items are eligible to be placed in reusable cooler bag 300. For example, FO system 113 may group items in the order into a “Reusable Bag” category if one or more properties of the items indicate that they are fresh, frozen, perishable, or otherwise benefits from thermally insulated packing.

In some alternative embodiments, all items may be assigned a property indicating if each item in the one or more databases is compatible with reusable cooler bag. For example, fresh produce, frozen items and/or perishable food items may be assigned “reusable-compatible” property in their corresponding data structures, and FO system 113 groups these items in “Reusable Bag” category based on this property. Meanwhile, items with sizes that are greater than the dimensions of reusable cooler bag 300, or are non-perishable, may be assigned “reusable-incompatible” property, and thus FO system 113 will never be group these items in the “Reusable Bag” category.

In step 406, FO system 113 associates the order to an eligible customer. In some embodiment, reusable cooler bag 300 is only available to a select group of customers, for example, a sub-set of customers who opted into a program by paying additional charge. To become an eligible customer, prior registration may be required. In some embodiment, customers who pre-register to become eligible customers may be identified in a list stored in one or more databases. FO system 113 receives information about the customer who places the order and attempts to associate the order with an eligible customer from the list stored in one or more databases. If FO system 113 finds a match between the ordering customer and an eligible customer, FO system 113 associates the order with the eligible customer. Alternatively, when placing the order, the customer may have explicitly indicated that he/she is an eligible customer, FO system 113 may only need to verify the association to the list of eligible customers by, for example, verifying customer's name, delivery address and/or any information suitable for identify verification.

In step 408, FO system 113 determines whether individual items in the order are to be placed in reusable cooler bag 300. In some embodiments, FO system 113 determines that all items for which “Reusable Bag” is “No”, as determined in step 404, will be packaged in conventional packaging in step 416. Additionally, if the order is not associated with a eligible customer to receive reusable cooler bag 300, FO system 113 may set all items in said order to “Reusable Bag” is “No”, and all items in said order will be packaged in conventional packaging in step 416.

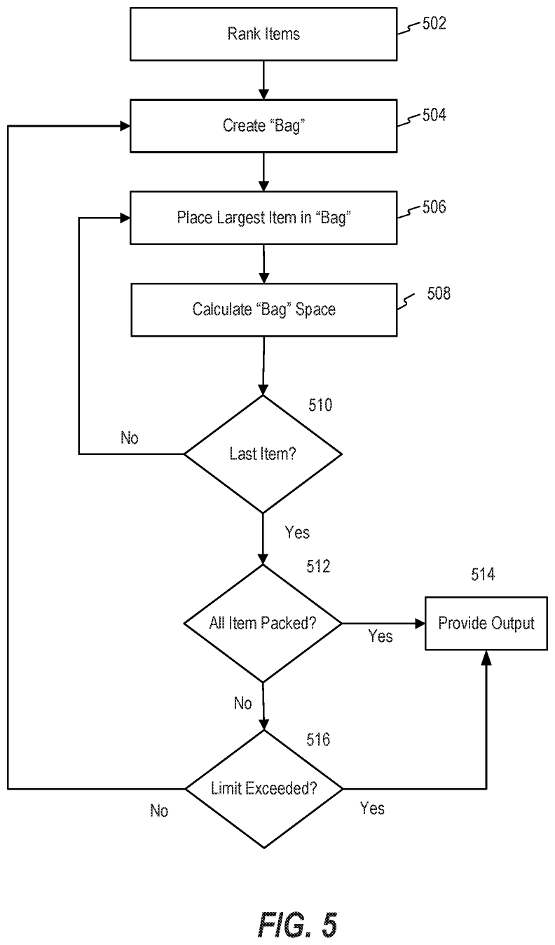

For items in the order where FO system 113 determines “Reusable Bag” is “YES” in step 408, FO system 113 proceeds to step 410 to simulate packing. In step 410, FO system 113 determines how reusable cooler bag 300 is to be packed, i.e., what items are placed in which one of one or more reusable cooler bag 300. FO system 113 generates an optimal packing solution in the form of a packing instruction, so that the least amount of reusable cooler bag 300 is used to package all eligible items in the order. Details on how the packing instruction is generated is described below with reference to FIG. 5.

In step 412, FO system 113 determines whether a number limit of reusable cooler bag 300 is exceeded. In some embodiments, each eligible customer may only be eligible to have a limited number of reusable cooler bags 300 in use or checked out at any one time. For example, if Customer A has 1 reusable cooler bag allotted, but FO system 113 determines that 2 reusable cooler bags are needed to completely package all eligible items in the order, the number limit of reusable cooler bag 300 is exceeded. In step 412, FO system 113 proceeds to instruct packaging the items that exceeds the number limit with conventional packaging in step 416, and proceed to instruct packaging the items that do not exceed the number limit with reusable cooler bag 300. For example, FO system 113 will instruct packaging eligible items from the order in the 1 reusable cooler bag available to Customer A, while the rest of the items will be conventionally packed.

In step 414, FO system 113 generates packing instructions based on simulations performed in step 410. The packing instructions may be viewed by warehouse workers through displays on devices such as 119A-119B from FIG. 1A.

In step 418, FO system 113 receives indications from mobile devices 119B, indicating that the items are packed. FO system 113 instructs delivery persons to deliver the items in the order by providing a notification to a mobile devices, e.g., one of 107A-107C from FIG. 1A.

In some embodiment, BMS 114 may carry out some or all steps in process 400. In some embodiments, BMS 114 and FO system 113 may carry out different steps in process 400.

FIG. 5 depicts a flow chart illustrating an exemplary embodiment of a method for efficient packaging of ordered items in the reusable cooler bag, consistent with the disclosed embodiments. Process 500 corresponds to step 410 of process 400.

Process 500 begins in step 502, where FO system 113 may rank the items in the order based on collected information such as dimensions or weights. For example, FO system 113 will rank the items from the largest to smallest by dimension size.

Process 500 then proceeds to step 504. In step 504, FO system 113 creates a data structure representing a reusable cooler bag. The data structure may comprise properties of the reusable cooler bag, including size and dimensions.

In step 506-510 FO system 113 may proceed with iteratively simulating packaging of a largest item of the group into a reusable cooler bag until all items are packaged in the first reusable cooler bag or the number limit is exceeded.

In step 506, FO system 113 selects the item with the greatest dimension that has yet to be placed in any data structures representing reusable cooler bags.

In step 508, FO system 113 will update the current data structure to subtract the dimensions from the current data structure to reflect that the item has taken up space in the reusable cooler bag. If the dimension of the current data structure after update is less than zero, FO systems 113 determines that the item does not fit into the first reusable cooler bag, the item will not be placed in the data structure. For example, if FO system 113 determines that a carton of milk would not fit into the first reusable cooler unused reusable cooler bags 614 because the updated space dimension of the current data structure is less than zero, FO system 113 will not place the carton of milk in the current data structure

In step 510, FO system 113 checks if there are items with smaller dimension that have yet to be placed. If one or more items with smaller dimension remain, “Last Item” is “No” and FO system 113 will repeat step 506. If the order contained no more items with smaller size, process 500 proceeds to step 512. For example, FO system will attempt to place the next largest item in the bag until all items in the order has been exhausted.

In step 512, FO system 113 determines if additional bags are required. If all items in the order has been placed in at least one data structure representing a reusable cooler bag, then “All Item Packed” is Yes, and no additional bag is required. Process 500 proceeds to step 514 to generate packing instruction. If at least one item has not been placed in a data structure representing reusable cooler bag, “All Item Packed” is “No,” and process 500 proceeds to step 516.

In step 516, FO system 113 checks if the number limit of reusable cooler bags is exceeded. For example, if Customer A has 1 reusable cooler bag allotted, but FO systems 113 determines in step 510 not all eligible items have been packed in reusable cooler bags, the number limit of reusable cooler bag is exceeded. When “Limit Exceeded” is “Yes,” process 500 ends and proceed to step 514. When “Limit Exceeded” is “No,” process 500 returns to step 504, where another data structure is created to represent another reusable cooler bag, and steps 504-512 repeat for the items that are have not been placed in any other data structures.

In step 514, FO systems 113 proceeds to step 414 or 416 in process 400, where the packing instruction for all items that are to be packed are generated based on the results of process 500, for example, the data structures representing reusable cooler bags. All items that are not placed in a data structured are to be packed conventionally in step 416.

In some embodiment, BMS 114 may carry out some or all steps in process 500. In some embodiments, BMS 114 and FO system 113 may carry out different steps in process 500.

A person of ordinary skill in the art will now appreciate that the example of packing operation is non-limiting, and alternative methods of packing reusable bag 300 may be implemented without departing from the present invention. Moreover, a person of ordinary skill in the art will also appreciate that although process 500 may be used to generate packing instruction for reusable cooler bags, it may also be used to generate packing instruction using other packing materials, including other thermally insulating packaging materials such as foam or paper packaging.

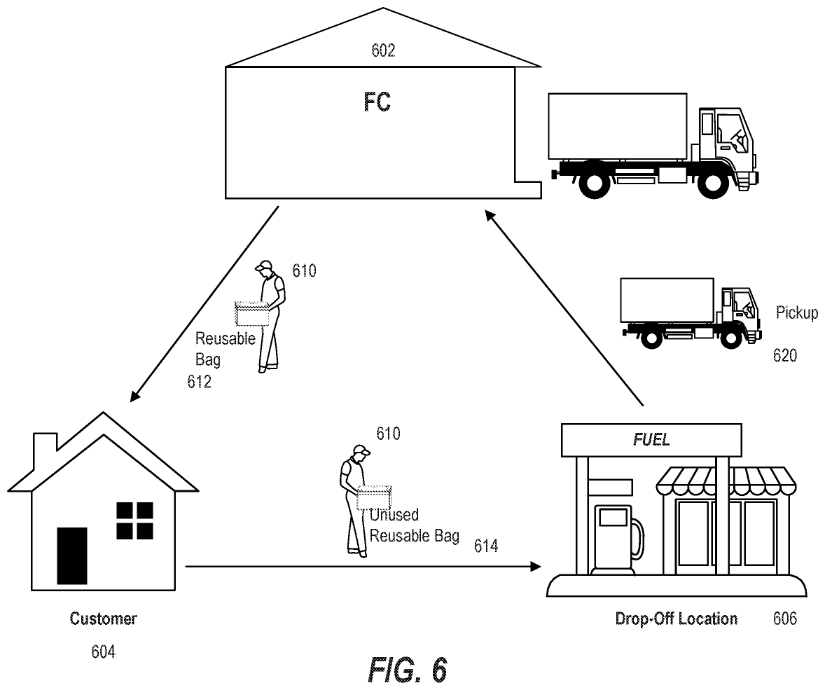

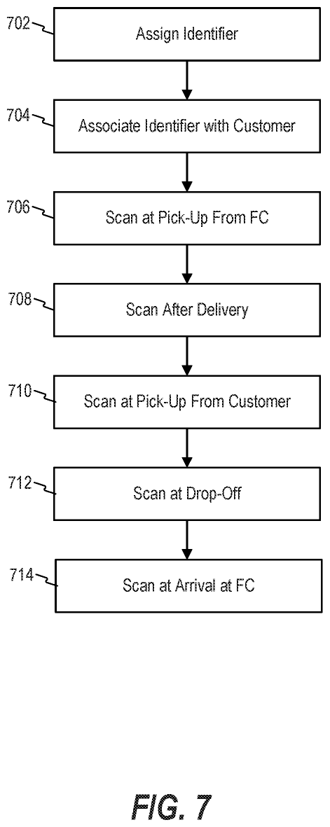

FIG. 6 is a schematic diagram illustrating an exemplary embodiment of a method for deploying and tracking the reusable cooler bags, corresponding to process 700 of FIG. 7, consistent with the disclosed embodiments.

Packed reusable cooler bags are delivered from FC 602, which may correspond to fulfillment center 200. A delivery person 610 may pick up one or more of reusable cooler bags 612 for delivery, and collects one or more unused reusable cooler bag 614 from customer. Delivery person 610 may be a flex worker 224B, or a full-time worker 224A. Reusable cooler bag 612 and unused reusable cooler bag 614 corresponds to reusable cooler bag 300 illustrated in FIG. 3.

In some embodiments, items of an order are packed in reusable cooler bag 612 at FC 602 by process 400. At a time prior to packing or delivery, a unique identifier may be assigned to each reusable cooler bag 612 in step 702. The unique identifier may correspond to an entry in one more data bases of transportation system 107 associated with a specific reusable cooler bag 612. The unique identifier may corresponds to barcode 302 illustrated in FIG. 3. The entry in transportation 107 may indicate at least one status of reusable cooler bag 612. For example, reusable cooler bag 612 may have a status indicating that it is being delivered, has been delivered, collected, dropped-off, and/or returned. The status may be updated in transportation system 107 so that the location of reusable cooler bag 612 may be tracked. The entry may also indicate which customer it is currently being associated.

At the end of process 400, when FO system 113 completes the packing operation, transportation system 107 may associate one or more of the identifiers with an eligible customer who is to receive the delivery using one or more reusable cooler bags 612 in step 704. Transportation system 107 updates the entry of specific reusable cooler bag 612 to associate it with a specific customer from the list of eligible customer.

In step 706, when delivery person 610 picks up reusable cooler bag 612 for delivery at FC 602, delivery person 610 updates the entry associated with reusable cooler bag 612. In some embodiments, updating the entry involves scanning of barcode 302 or shipping label 304 using mobile devices 107A-107C. Transportation system 107 changes a status of reusable cooler bag 612 to indicate that reusable cooler bag 612 is being delivered. For example, when beginning to deliver reusable cooler bags 612 from FC 602 to customer 604, delivery person 610 scans reusable cooler bags 612 so that Transportation system 107 updates the entry of Bag A to indicate it is currently located with delivery person 610.

Delivery person 610 arrives at customer 604 and delivers reusable cooler bag 612 containing items of the order. Upon delivery, in step 708, delivery person 610 updates the status of reusable cooler bag 612. For example, when reusable cooler bags 612 is delivered, delivery person 610 scans reusable cooler bags 612 so that Transportation system 107 updates the entry associated with reusable cooler bags 612 to indicate that it is currently located with customer 604.

In some embodiments, in step 710, when delivery person 610 is at customer 604, delivery person 610 picks up unused reusable cooler bag 614 and updates transportation system 107 to indicate change of status of unused reusable cooler bag 614. For example, delivery person 610 checks if there are unused reusable cooler bag from previous deliveries. If such bags are found, delivery person 610 scans unused reusable cooler bags 614. Transportation system 107 updates entry of unused reusable cooler bags 614 to indicate that unused reusable cooler bags 614 is no longer located with customer 604, but has been collected by delivery person 610. A person having ordinary skill in the art will now appreciate that “612” and “614” are used here only to differentiate the reusable cooler bags that are being delivered and reusable cooler bags that are being collected, but otherwise 612 may be 614 are identical. In some embodiments, transportation system 107 may generate alerts and send the alerts for display on mobile device 107A-107C associated with delivery person 610. The alerts remind delivery person 610 to check for presence of any unused reusable cooler bag 614 at the time of completing delivery. In some embodiment, the alerts may be displayed in the instance when delivery person 610 uses mobile device 107A-107C to scan items confirming delivery.

In some embodiments, delivery person 610 proceeds to drop-off unused reusable cooler bag 614 at drop-off location 606. Drop-off location 606 may be a convenience store, gas station, or any readily accessible locations for delivery person 610. In some embodiments, drop-off locations 606 may be more numerous in number than FC 602, and may therefore more convenient for delivery person 610. For example, delivery person 610 may be a “flex” worker 224B, who do not wish to return to FC 602 after the delivery. Thus, it may be more convenient for the “flex” worker 224B to drop-off unused reusable cooler bag 614 at locations en route to his/her next destination, other than FC 602. In step 712, when delivery person 610 drops-off unused reusable cooler bag 614 at drop-off location 606, delivery person 610 updates Transportation system 107 to indicate change of status of unused reusable cooler bag 614. For example, delivery person 610 scans unused reusable cooler bags 614 when dropping-off Unused reusable cooler bags 614, so that Transportation system 107 updates entry of Unused reusable cooler bags 614 to indicate that unused reusable cooler bags 614 is no longer with delivery person 610, but is now located at drop-off location 606.

In some embodiments, drop-off locations may be equipped with secure containers or areas. Delivery person 610 drops off unused reusable cooler bag 614 in these secure containers or areas, so that they may be protected from theft or damage. For example, secure containers or areas may be protected by a locking mechanism, which only delivery person 610 may access through mobile devices 107A-C.

In some embodiments, at some predetermined time interval, pick-up personnel 620 takes all unused reusable cooler bag 614 at drop-location 606 and return them to FC 602. Pick-up personnel 620 may be full-time delivery worker 224A. Once unused reusable cooler bag 614 arrives at FC 602, workers at FC 602 updates Transportation system 107 to indicate change of status of unused reusable cooler bag 614 in step 714. For example, warehouse workers scan unused reusable cooler bags 614 so that Transportation system 107 updates the entry of unused reusable cooler bags 614 to indicate that unused reusable cooler bags 614 is returned to FC 602, ready to be used for packaging in process 400. In some embodiments, once unused reusable cooler bag 614 returns to FC 602, Transportation system 117 de-associates unused reusable cooler bag 614 from customer 604 by removing customer 604 from the entry. Unused reusable cooler bag 614 may be ready to be associated with a different customer for another delivery.

In some embodiment, BMS 114 may carry out some or all steps in process 700. In some embodiments, BMS 114, transportation system 117 and FO system 113 may carry out different steps in process 700.

An ordinary skilled person will now appreciate that the process 700 is non-limiting, and alternative embodiments may be implemented without departing from the present invention. For example, in some alternative embodiments, delivery person 610 may return unused reusable cooler bag 614 directly to FC 602. In another alternative embodiments, customer 604 may request a pick-up of unused reusable cooler bag 614, without having to wait for delivery person 610 to arrive with items for delivery. In yet another alternative embodiment, delivery person 610 may arrive with items not packaged with reusable cooler bag 612, and may still proceed to pick up any unused reusable cooler bags 614 located with customer 604.

In some embodiments, customers who participate in a program using the reusable cooler bag are encouraged to make the reusable cooler bags ready for collection as often as possible, so that more reusable cooler bags may be available in circulation. In some embodiments, when customer 604 keeps possession of an unused reusable cooler bag 614 beyond a predetermined time, such as 90 days, FO system 113 may assign a status of “Overdue” to the identifier associated with the particular unused reusable cooler bag 614, and customer 604 may incur a penalty charge as a result. In some embodiments, customers may pay a deposit in order to join the program to use the reusable cooler bag. FO system 113 may deduct the penalty charge from the deposit amount of customer 604.

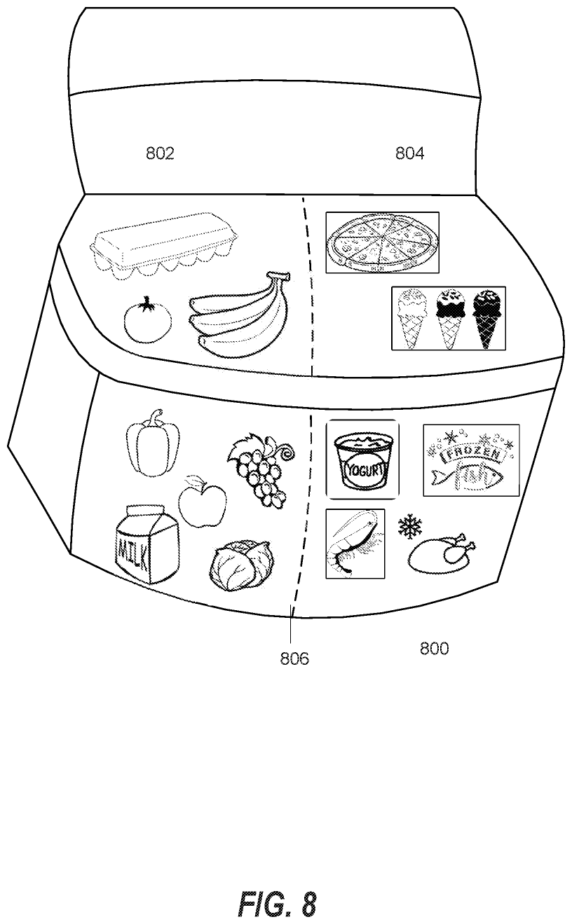

FIG. 8 depicts an embodiment of a reusable cooler bag 800 containing multiple types of items. Reusable cooler bag 800 is divided into two or more spaces, divided by a divider 806. For example, reusable cooler bag 800 can be divided into first temperature zone 802 and second temperature zone 804. For example, the first temperature zone may correspond to frozen items (e.g., ice cream) and the second temperature zone may correspond to fresh items (e.g., produce).

In some embodiments, during process 400, FO system 113 determines, based on item properties determined in step 404, that an order contain items that require different levels of temperature control. Thus, if process 500 returns a packing instruction that that packs these items in the same reusable cooler bag 800, FO system 113 instructs warehouse worker to insert divider 806 to separate these items into their appropriate temperature zones.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computerized system for reusable storage tracking and distribution, comprising:
at least one processor; and
at least one non-transitory storage medium comprising instructions that, when executed by the at least one processor, cause the at least one processor to perform steps comprising:
receiving, from a remote system, an order associated with a customer and comprising a plurality of items;
searching at least one data store to determine one or more tags associated with the items;
determining that the customer is assigned to one or more reusable packages for delivery of the at least one item in the order;
based on the determined one or more tags and a number of the items in the order, sorting the items into at least one group;
for at least one group:
determining, based on the number of the items in the group and the dimensions of the items in the group, a count of reusable packages, wherein the count of reusable package is less than or equal to the number of reusable packages assigned to the customer;
generating instructions comprising: an indication of an identifier for each item in the group and information representing an associated reusable package for packaging the respective item, wherein the associated reusable package for packaging the respective item is selected based on a process comprising:
creating, by the at least one processor, a data structure representing the associated reusable package and comprising one or more dimensions of the associated reusable package;
simulating packaging the respective item in the associated reusable package by subtracting a greatest dimension of the respective item from the one or more dimensions of the associated reusable package;
determining whether the subtracted one or more dimensions is equal to or greater than zero; and
in response to a determination that the subtracted one or more dimensions is equal to or greater than zero, selecting the associated reusable package for packaging the respective item;
sending the generated instructions to a first mobile device for display;
receiving a scan event from the first mobile device comprising a reusable package identifier;
sending a communication to a second mobile device associated with a delivery worker, comprising:
the reusable package identifier;
a delivery location; and
a number of reusable packages for pickup;
receiving a scan event from the second mobile device, comprising an identifier of a second reusable package;
updating the number of reusable packages assigned to the customer based on the scan event.

2. The system of claim 1, wherein the steps further comprise:
determining that a first item in the order is associated with a tag for a first temperature and that a second item in the order is associated with a tag for a second temperature;
assigning the first item to a first group; and
assigning the second item to a second group, further wherein
the reusable packages comprise insulated containers for holding the at least one items.

3. The system of claim 1, wherein the steps further comprise:
assigning a plurality of package identifiers with a customer identifier by creating entries in a database associating the customer identifier with the plurality of package identifiers.

4. The system of claim 3, wherein creating entries in the database further comprises:
receiving, from the second mobile device at delivery location, a second scan event comprising a package identifier;
add at least one entry to the database associating the customer identifier with the received package identifier.

5. The system of claim 3, wherein the steps further comprise:
receiving a second scan event from a device at a second location separate from the delivery location, the second scan event comprising one or more package identifiers;
searching the database using the received package identifier;
modifying an entry in the database to de-associate the package identifier from the customer identifier.

6. The system of claim 1, wherein the communication sent to the second mobile device comprises identifiers associated with the reusable packages for pickup.

7. The system of claim 1, wherein the steps further comprise:
receiving a notification from customer to pick up a reusable package, including an identifier associated with the reusable package;
determining send notification to delivery device indicating to pick up

8. The system of claim 1, wherein determining the count of reusable packages for a group comprises performing an optimization process, by:
selecting a data structure representing a first package, the data structure comprising properties of the first package;
iteratively simulating packaging of a largest item of the group into the first package until all items are packaged in the first package, wherein if the simulating determines that the items in the group do not fit into the first package:
choosing a second package, and
iteratively computationally packing the largest item until all items are packed in the second package.

9. The system of claim 8, wherein iteratively simulating packaging further comprises:
determining dimensions of at least one item in the group;
determining the largest item of the group based on determining an item with a longest dimension;
simulating packing the largest item into the first package;
calculating remaining spaces in the first package by subtracting the dimensions of the largest item from the dimensions of the first package; and
iteratively simulating packing at least one remaining item in the group into the calculated remaining spaces.

10. A method for reusable storage tracking and distribution, comprising:
receiving, from a remote system, an order associated with a customer and comprising a plurality of items;
searching at least one data store to determine one or more tags associated with each of the items;
determining that the customer is assigned to one or more reusable packages for delivery of the at least one item in the order;
based on the determined one or more tags and a number of the items in the order, sorting the items into at least one group;
for at least one group:
determining, based on the number of the items in the group and the dimensions of the items in the group, a count of reusable packages, wherein the count of reusable package is less than or equal to the number of reusable packages assigned to the customer;
generating instructions comprising: an indication of an identifier for each item in the group and information representing an associated reusable package for packaging the respective item, wherein the associated reusable package for packaging the respective item is selected based on a process comprising:
creating, by the at least one processor, a data structure representing the associated reusable package and comprising one or more dimensions of the associated reusable package;
simulating packaging the respective item in the associated reusable package by subtracting a greatest dimension of the respective item from the one or more dimensions of the associated reusable package;
determining whether the subtracted one or more dimensions is equal to or greater than zero; and
in response to a determination that the subtracted one or more dimensions is equal to or greater than zero, selecting the associated reusable package for packaging the respective item;
sending the generated instructions to a first mobile device for display;
receiving a scan event from the first mobile device comprising a reusable package identifier;
sending a communication to a second mobile device associated with a delivery worker, comprising:
the reusable package identifier;
a delivery location; and
a number of reusable packages for pickup;
receiving a scan event from the second mobile device, comprising an identifier of a second reusable package;
updating the number of reusable packages assigned to the customer based on the scan event.

11. The method of claim 10, further comprising:
determining that a first item in the order is associated with a tag for a first temperature and that a second item in the order is associated with a tag for a second temperature;
assigning the first item to a first group; and
assigning the second item to a second group, further wherein
the reusable packages comprise insulated containers for holding the at least one item.

12. The method of claim 10, further comprising:
assigning a plurality of package identifiers with a customer identifier by creating entries in a database associating the customer identifier with the plurality of package identifiers.

13. The method of claim 12, wherein creating entries in the database further comprises:
receiving, from the second mobile device at delivery location, a second scan event comprising a package identifier;
add at least one entry to the database associating the customer identifier with the received package identifier.

14. The method of claim 12, further comprising:
receiving a second scan event from a device at a second location separate from the delivery location, the second scan event comprising one or more package identifiers;
searching the database using the received package identifier;
modifying an entry in the database to de-associate the package identifier from the customer identifier.

15. The method of claim 10, wherein the communication sent to the second mobile device comprises identifiers associated with the reusable packages for pickup.

16. The method of claim 10, further comprising:
receiving a notification from customer to pick up a reusable package, including an identifier associated with the reusable package;
determining send notification to delivery device indicating to pick up

17. The method of claim 10, further comprising, wherein determining the count of reusable packages for a group comprises performing an optimization process, by:
selecting a data structure representing a first package, the data structure comprising properties of the first package;
iteratively simulating packaging of a largest item of the group into the first package until all items are packaged in the first package, wherein if the simulating determines that the items in the group do not fit into the first package:
choosing a second package, and
iteratively computationally packing the largest item until all items are packed in the second package.

18. The method of claim 17, wherein iteratively simulating packaging further comprises:
determining dimensions of at least one item in the group;
determining the largest item of the group based on determining an item with a longest dimension;
simulating packing the largest item into the first package;
calculating remaining spaces in the first package by subtracting the dimensions of the largest item from the dimensions of the first package; and
iteratively simulating packing at least one remaining item in the group into the calculated remaining spaces.

19. The method of claim 10, further comprising:
generating instructions to the first mobile device to display an indication to pack at least one item not using a reusable package when the count of reusable packages exceeds a predetermined number.

20. A computerized system for reusable storage tracking and distribution, comprising:
at least one processor; and
at least one non-transitory storage medium comprising instructions that, when executed by the at least one processor, cause the at least one processor to perform steps comprising:
receiving, from a remote system, an order associated with a customer and comprising a plurality of items;
searching at least one data store to determine one or more tags associated with each of the items;
determining that the customer is assigned to one or more reusable packages for delivery of the at least one item in the order;
based on the determined one or more tags and a number of the items in the order, sorting the items into at least one group;
for at least one group:
determining, based on the number of the items in the group and the dimensions of the items in the group, a count of reusable packages, wherein the count of reusable packages is less than or equal to the number of reusable packages assigned to the customer;
generating instructions comprising: an indication of an identifier for each item in the group and information representing an associated reusable package for packaging the respective item, wherein the associated reusable package for packaging the respective item is selected based on a process comprising:
generating instructions comprising: an indication of an identifier for each item in the group and information representing an associated reusable package for packaging the respective item, wherein the associated reusable package for packaging the respective item is selected based on a process comprising:
creating, by the at least one processor, a data structure representing the associated reusable package and comprising one or more dimensions of the associated reusable package;
simulating packaging the respective item in the associated reusable package by subtracting a greatest dimension of the respective item from the one or more dimensions of the associated reusable package;
determining whether the subtracted one or more dimensions is equal to or greater than zero; and
in response to a determination that the subtracted one or more dimensions is equal to or greater than zero, selecting the associated reusable package for packaging the respective item;
sending the generated instructions to a first mobile device for display;
receiving a scan event from the first mobile device comprising a reusable package identifier;
sending a communication to a second mobile device associated with a delivery worker, comprising:
the reusable package identifier;
a delivery location; and
a number of reusable packages for pickup;
receiving a scan event from the second mobile device, comprising an identifier of a second reusable package.
